(19) United States
(12) Patent Application Publication
(10) Pub. No.: US 2015/0363785 A1
(43) Pub. Date: Dec. 17, 2015

(54) SYSTEMS AND METHODS FOR CONSUMER AUTHENTICATION USING BEHAVIORAL BIOMETRICS

(71) Applicant: MasterCard International Incorporated, Purchase, NY (US)

(72) Inventors: Kristofer Perez, New York, NY (US); Pedro J. Chavarria, Hampton Bays, NY (US)

(21) Appl. No.: 14/303,155

(22) Filed: Jun. 12, 2014

(51) Int. Cl. G06Q 20/40; G06Q 20/20; G06Q 20/34

(52) U.S. Cl. CPC G06Q 20/40145; G06Q 20/3552; G06Q 20/20

(57) ABSTRACT

A computer-based method for consumer authentication of payment card transactions using behavioral biometrics uses a computer device including a processor and a memory. The method includes identifying behavioral biometric profile data of an approved cardholder that is approved to use a payment card issued by an issuer. The method also includes receiving behavioral biometric sample data of a suspect consumer collected during a payment card transaction in which the suspect consumer presents the payment card for use. The method further includes comparing the behavioral biometric sample data of the suspect consumer to the behavioral biometric profile data of the approved cardholder. The method also includes computing an authentication value based at least in part on the comparing. The method further includes authenticating the suspect consumer as the approved cardholder based at least in part on the authentication value.

### BACKGROUND OF THE DISCLOSURE

This disclosure relates generally to consumer authentication during payment card transactions and, more specifically, to systems and methods for authenticating consumers using behavioral biometrics captured during payment card transactions.

Biometrics refers generally to the quantifiable data related to human characteristics and traits. In some known systems, biometrics are used to authenticate people. A reference sample is collected from an individual, or “reference individual,” and stored as an authentic sample, or “template,” of that particular individual. Later, a suspect sample is collected from a suspect individual and compared against the reference sample. If the suspect sample matches the reference sample, then the suspect individual is verified as being the reference individual. For example, finger prints are one type of biometric that may be used to verify (i.e., authenticate) a person's identity. Some known systems use finger print biometrics for access control systems used in physically securing a premise. A reference sample of an individual's finger print is collected, stored, and associated with that individual's credentials, such as the individual's name and a badge number. At the time the individual seeks entry to the premise, a sample of the individual's finger print is taken and compared to the reference sample. If the comparison is successful, then the individual is authenticated and allowed access.

In payment card transactions, interchange networks such as MasterCard® seek to authenticate individuals during a transaction in order to prevent fraudulent use of payment cards. Biometrics presents one possible method of authenticating the suspect individual. However, the collection of certain types of biometric data such as finger prints or iris scans requires special hardware (e.g., a finger print reader or an iris scanner) that may be too costly or impractical to deploy in many commercial settings.

### BRIEF DESCRIPTION OF THE DISCLOSURE

In one aspect, a computer-based method for consumer authentication of payment card transactions using behavioral biometrics is provided. The method uses a computer device including a processor and a memory. The method includes identifying behavioral biometric profile data of an approved cardholder that is approved to use a payment card issued by an issuer. The method also includes receiving behavioral biometric sample data of a suspect consumer collected during a payment card transaction in which the suspect consumer presents the payment card for use. The method further includes comparing the behavioral biometric sample data of the suspect consumer to the behavioral biometric profile data of the approved cardholder. The method also includes computing an authentication value based at least in part on the comparing. The method further includes authenticating the suspect consumer as the approved cardholder based at least in part on the authentication value.

In another aspect, a computing device for consumer authentication of payment card transactions using behavioral biometrics is provided. The computing device includes a processor communicatively coupled to a memory. The computing device is programmed to identify behavioral biometric profile data of an approved cardholder that is approved to use a payment card issued by an issuer. The computing device is also programmed to receive behavioral biometric sample data of a suspect consumer collected during a payment card transaction in which the suspect consumer presents the payment card for use. The computing device is further programmed to compare the behavioral biometric sample data of the suspect consumer to the behavioral biometric profile data of the approved cardholder. The computing device is also programmed to compute an authentication value based at least in part on the comparing. The computing device is further programmed to authenticate the suspect consumer as the approved cardholder based at least in part on the authentication value.

In yet another aspect, at least one non-transitory computer-readable storage media having computer-executable instructions embodied thereon is provided. When executed by at least one processor, the computer-executable instructions cause the processor to identify behavioral biometric profile data of an approved cardholder that is approved to use a payment card issued by an issuer. The computer-executable instructions also cause the processor to receive behavioral biometric sample data of a suspect consumer collected during a payment card transaction in which the suspect consumer presents the payment card for use. The computer-executable instructions further cause the processor to compare the behavioral biometric sample data of the suspect consumer to the behavioral biometric profile data of the approved cardholder. The computer-executable instructions also cause the processor to compute an authentication value based at least in part on the comparing. The computer-executable instructions further cause the processor to authenticate the suspect consumer as the approved cardholder based at least in part on the authentication value.

### BRIEF DESCRIPTION OF THE DRAWINGS

FIGS. 1-8 show example embodiments of the methods and systems described herein.

FIG. 1 is a schematic diagram illustrating an example multi-party transaction card industry system for authorizing payment card transactions in which a suspect cardholder may be authenticated using behavioral biometrics collected at the time of a transaction.

FIG. 2 is a simplified block diagram of an example computing system for authenticating suspect individuals during payment card transactions using behavioral biometrics.

FIG. 3 is an expanded block diagram of an example embodiment of a server architecture of a behavioral biometric authentication system including other computer devices in accordance with one embodiment of the present disclosure.

FIG. 4 illustrates an example configuration of a user system operated by a user, such as the cardholder shown in FIGS. 1 and 6 or the suspect consumer shown in FIG. 6.

FIG. 5 illustrates an example configuration of a server system such as the server system shown in FIGS. 2 and 3.

FIG. 6 is an example payment card transaction environment that includes an authentication system which authenticates a suspect consumer as an approved cardholder.

FIG. 7 is an example method for authenticating suspect consumers during payment card transactions in a payment card transaction environment such as shown in FIG. 6.

FIG. 8 shows an example configuration of a database within a computing device, along with other related computing components, that may be used to authenticate a suspect consumer in a payment card transaction environment such as the transaction environment shown in FIG. 6.

### DETAILED DESCRIPTION OF THE DISCLOSURE

Systems and methods are described herein for providing biometric authentication during payment card transactions using behavioral biometrics. More specifically, the systems and methods described herein enable a suspect individual to be authenticated using behavioral data captured during the execution of a payment card transaction. In one example embodiment, a behavioral profile is created for a reference individual (e.g., an approved cardholder or privileged cardholder, i.e., a person that is approved by the issuer to use the card). The behavioral profile may be created using one or more samples collected during a configuration stage (e.g., during card registration), or may be collected over a period of time (e.g., from several actual payment card transactions). This behavioral profile is associated with the cardholder's payment card(s) and functions as a reference sample or template that may be used to authenticate use of the payment card during later transactions.

This system is configured and customized to certain transaction venues or settings such as, for example, card-not-present transactions using a personal computer or mobile computing device, or in-store transactions using a point-of-sale device. In each venue type, different behavioral biometric data may be available. For example, in a traditional brick-and-mortar storefront setting, the consumer may interact with a point-of-sale device that may include a keypad or touchscreen for data entry or other authentication and authorization steps. In a personal computer setting, the personal computer may include a particular operating system with a mouse and keyboard through which a consumer may perform a payment card transaction using a particular web browser interface. In a handheld computer setting, the tablet may include a different operating system with a touch screen for data entry and manipulation operations, and the consumer may use a web browser application (app) or another app to perform the payment card transaction. As such, each venue may present differing hardware, software, or other environmental factors for conducting the payment card transaction, each of which may present different behaviors or behavioral biometrics data from the consumer, and thus different behavioral biometric comparisons for authentication.

During a later transaction, the system identifies the venue type of the transaction and collects behavioral biometric sample data (i.e., the suspect sample) associated with that venue type. The behavioral biometric sample data is then used to compare the suspect sample with the reference sample, thereby authenticating the suspect individual.

A technical effect of the systems and processes described herein include at least one of: (a) identifying behavioral biometric profile data of an approved cardholder that is approved to use a payment card issued by an issuer; (b) receiving behavioral biometric sample data of a suspect consumer collected during a payment card transaction in which the suspect consumer presents the payment card for use; (c) comparing the behavioral biometric sample data of the suspect consumer to the behavioral biometric profile data of the approved cardholder; (d) computing an authentication value based at least in part on the comparing; (e) authenticating the suspect consumer as the approved cardholder based at least in part on the authentication value; (f) receiving behavioral biometric sample data at a point-of-sale device within a merchant's business premise, wherein the behavioral biometric sample data includes one or more of keystroke dynamics and signature dynamics; (g) receiving behavioral biometric sample data from a computing device remote from a merchant's business premise, wherein the behavioral biometric sample data includes one or more of keystroke dynamics and mouse dynamics; (h) receiving behavioral biometric sample data including cognition-related behavioral data; (i) receiving behavioral biometric sample data including timing data associated with behaviors performed by the suspect consumer during the payment card transaction; (j) determining a venue type associated with the payment card transaction, wherein identifying behavioral biometric profile data further includes identifying behavioral biometric profile data matching the venue type; (k) identifying behavioral biometric profile data collected from one or more historical payment card transactions; (l) identifying behavioral biometric profile data sampled from the approved cardholder during a registration process.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. As used herein, the term “payment account” is used generally to refer to the underlying account with the transaction card. In addition, cardholder card account behavior can include but is not limited to purchases, management activities (e.g., balance checking), bill payments, achievement of targets (meeting account balance goals, paying bills on time), and/or product registrations (e.g., mobile application downloads).

The following detailed description illustrates embodiments of the disclosure by way of example and not by way of limitation. It is contemplated that the disclosure has general application to authenticating financial transactions in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

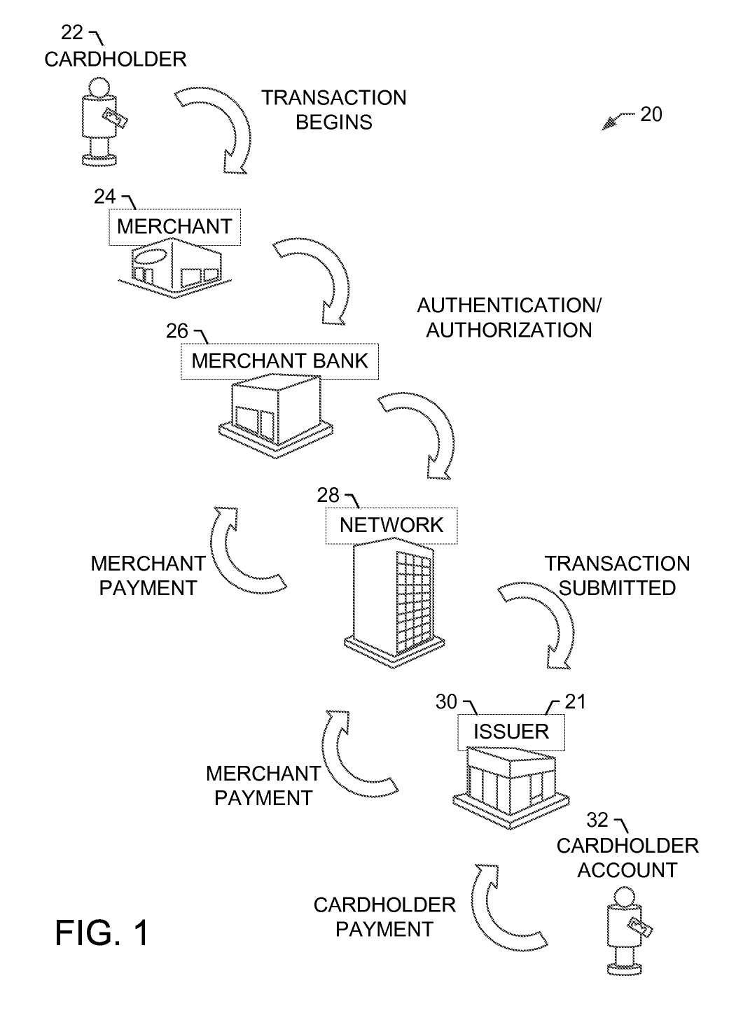

FIG. 1 is a schematic diagram illustrating an example multi-party transaction card industry system 20 for authorizing payment card transactions in which a suspect cardholder may be authenticated using behavioral biometrics collected at the time of a transaction. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, New York).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

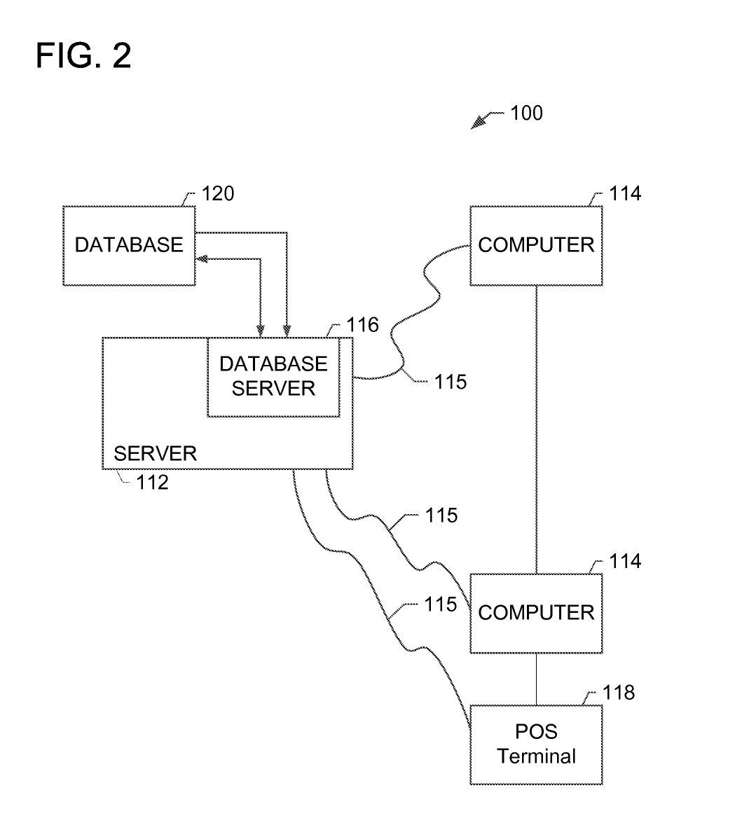

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2). Further, in some embodiments, interchange network 28 and/or issuer bank 30 stores in database 120 information associated with a loyalty program such as, for example, an amount of loyalty points associated with the cardholder and/or the transaction.

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, savings information, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described above, the various parties to the payment card transaction include one or more of the parties shown in FIG. 1 such as, for example, cardholder 22, merchant 24, merchant bank 26, interchange network 28 (also referred to herein as payment processor 28), issuer bank 30, and/or an issuer processor 21. In some cases, a rewards program may be offered to cardholders that use system 20. The rewards program may be offered and managed by one or more of merchant 24, interchange network 28, issuer 30, and issuer processor 21.

Further, an authentication step may be performed prior to or during authorization of the transaction. During the transaction, the person presenting the payment card as a part of the transaction (i.e., the suspect individual) is investigated as to whether she is a person approved to use the payment card (i.e., the cardholder 22). In embodiments described herein, behavioral biometric sample data of the suspect individual is collected and compared to a pre-determined reference sample or profile. In some embodiments, authentication may be performed prior to or contemporaneous with the authorization steps described above, and may affect the outcome of the transaction (e.g., the transaction may be denied based at least in part on unsatisfactory authentication).

FIG. 2 is a simplified block diagram of an example computing system 100 for authenticating suspect individuals during payment card transactions using behavioral biometrics. System 100 includes a plurality of computer devices connected in communication in accordance with the present disclosure. In the example embodiment, system 100 may be used to collect and/or analyze biometric data from one or more consumers prior to and during payment card transactions. More specifically, in the example embodiment, system 100 includes a server system 112 in communication with a point-of-sale (POS) terminal 118 at a merchant location, such as merchant 24 (shown in FIG. 1), and/or other client systems 114 associated with merchants, merchant banks, payment networks, issuer banks, and/or cardholders.

In the example embodiment, server system 112 is also in communication with a plurality of client sub-systems, also referred to as client systems 114. In one embodiment, client systems 114 are computers including a web browser, such that server system 112 is accessible to client systems 114 using the Internet or other network. Client systems 114 are interconnected to the network through many interfaces including a network 115, such as a local area network (LAN) or a wide area network (WAN), dial-in-connections, cable modems, special high-speed Integrated Services Digital Network (ISDN) lines, and RDT networks. Client systems 114 could be any device capable of interconnecting to the Internet including a web-based phone, PDA, or other web-based connectable equipment. Client systems 114 may be used by cardholders and/or merchants to conduct payment card transactions as described herein.

In the example embodiment, system 100 also includes POS terminals 118, which may be connected to client systems 114 and may be connected to server system 112. POS terminals 118 may be interconnected to the Internet (or any other network that allows the POS terminals 118 to communicate as described herein) through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a cardholder's financial transaction card. In some embodiments, POS terminal 118 may be a cardholder's personal computer, such as when conducting an online purchase through the Internet. As used herein, the terms POS device, POS terminal, and point of interaction device are used broadly, generally, and interchangeably to refer to any device in which a cardholder interacts with a merchant to complete a payment card transaction.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities and savings activities conducted over the processing network including data relating to merchants, account holders or customers, issuers, acquirers, savings amounts, savings account information, and/or purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may also store loyalty rewards information.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28 or a payment processor. In the example embodiment, server system 112 is associated with a network interchange, such as interchange network 28, and may be referred to as an interchange computer system or a payment processing computing device. Server system 112 may be used for processing transaction data. In addition, client systems 114 and/or POS terminal 118 may include a computer system associated with at least one of an online bank, a bill payment outsourcer, an acquirer bank, an acquirer processor, an issuer bank associated with a transaction card, an issuer processor, a remote payment system, a token requestor, a token provider, and/or a biller.

In the example embodiment, system 100 includes behavioral biometric data such as, for example, reference samples associated with a plurality of venue types and/or a plurality of approved cardholders. Further, system 100 includes an authentication module configured to perform one or more of the authentication tasks described herein, such as, for example, receiving suspect behavioral biometric samples and comparing those samples to the reference samples.

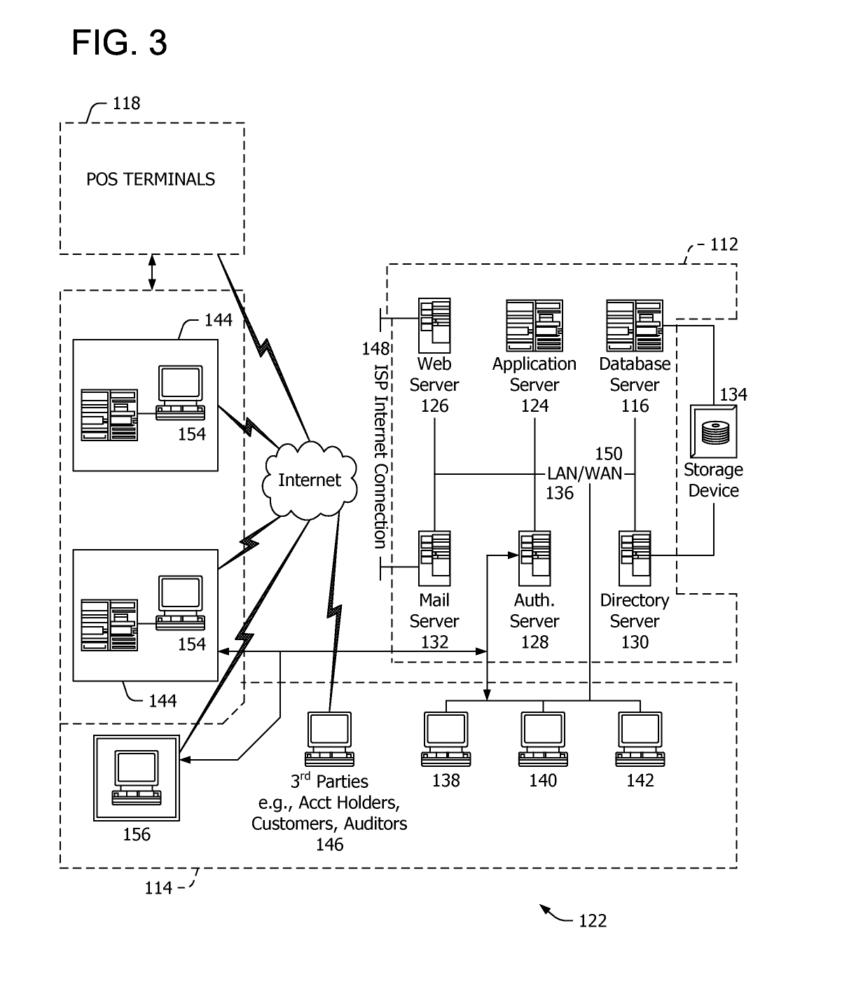

FIG. 3 is an expanded block diagram of an example embodiment of a server architecture of a behavioral biometric authentication system 122 including other computer devices in accordance with one embodiment of the present disclosure. Components in system 122, identical to components of system 100 (shown in FIG. 2), are identified in FIG. 3 using the same reference numerals as used in FIG. 2. Authentication system 122 includes server system 112, client systems 114, and POS terminals 118. Server system 112 further includes database server 116, a rewards system 102, a web server 126, a user authentication system 106, a CSS system 104, and an application server 124. A storage device 134 is coupled to database server 116 and CSS system 104. Servers 116, 124, 126, 128, 130, and 132 are coupled in a local area network (LAN) 136. In addition, an issuer bank workstation 138, an acquirer bank workstation 140, and a third party processor workstation 142 may be coupled to LAN 136. In the example embodiment, issuer bank workstation 138, acquirer bank workstation 140, and third party processor workstation 142 are coupled to LAN 136 using network connection 115. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, cardholders (i.e., consumers), merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, authentication server 128 communicates with remotely located client systems, including a client system 156 using a telephone link. Authentication server 128 is configured to communicate with other client systems 138, 140, and 142 as well.

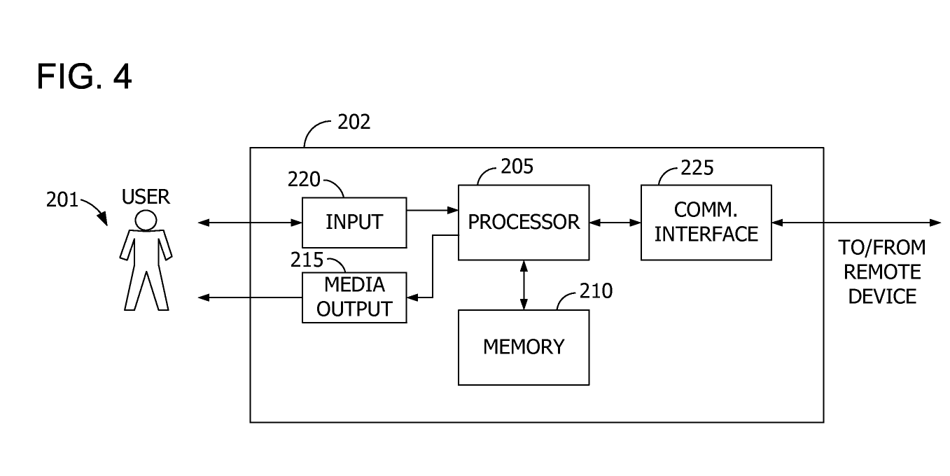

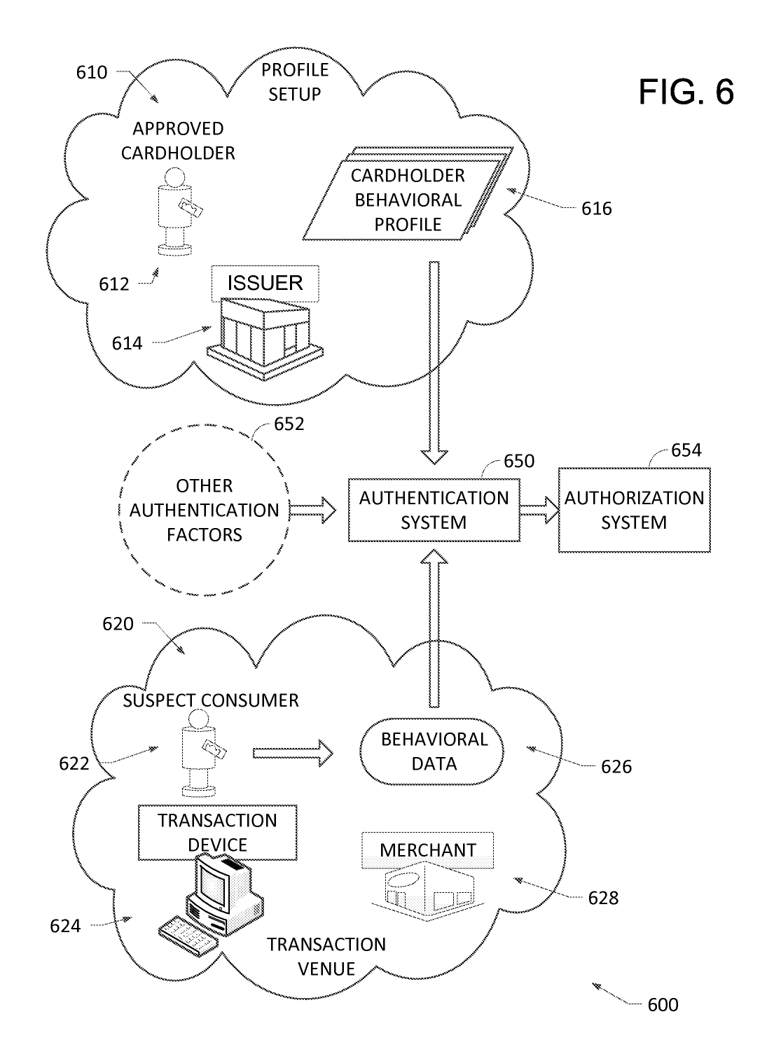

FIG. 4 illustrates an example configuration of a user system 202 operated by a user 201, such as cardholder 22 (shown in FIG. 1), approved cardholder 612 (shown in FIG. 6), and/or suspect consumer 622 (shown in FIG. 6). User system 202 may include, but is not limited to, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

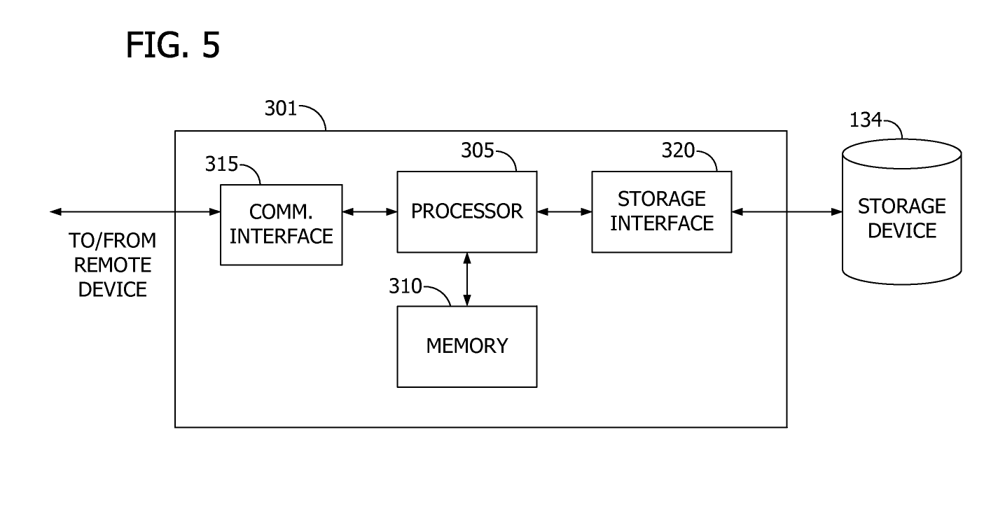

FIG. 5 illustrates an example configuration of a server system 301 such as server system 112 (shown in FIGS. 2 and 3). Server system 301 may include, but is not limited to, database server 116, application server 124, web server 126, authentication server 128, and directory server 130 (all shown in FIG. 3).

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

FIG. 6 is an example payment card transaction environment 600 that includes an authentication system 650 which authenticates a suspect consumer 622 as an approved cardholder 612. In some embodiments, authentication system 650 may be similar to system 100 (shown in FIG. 1) and/or behavioral biometric authentication system 122 (shown in FIG. 3). In the example embodiment, an issuing bank 614 configures an approved cardholder (i.e., the reference individual) 602 with one or more behavior profiles 616 during a profile setup process 610. Issuer 614 associates these profiles 616 with one or more payment cards of cardholder 612. Issuer 614 may be similar to issuer 21 (shown in FIG. 1). Behavioral profiles 616 may be stored in a system associated with issuer 614, or with interchange network 28 (shown in FIG. 1), or merchant bank 26 (shown in FIG. 1), or some other third party processor.

During a payment card transaction at a transaction venue 620, a suspect consumer 622 presents a payment card to a merchant 628. In the example embodiment, suspect consumer 622 interacts with a transaction device 624 during the transaction. Transaction device 624 captures behavioral biometric sample data 626 during the course of the transaction. As used herein, the terms “behavioral biometric transaction data” and “behavioral biometric sample data” are used generally to refer to the behavioral data captured during a transaction that may be used to compare to behavioral profile data for authentication of the suspect consumer. Further, as used herein, the terms “behavioral profile” and “behavioral biometric profile” are used generally to refer to the data (e.g., the reference sample(s)) that may be used as a reference sample to compare against a behavioral sample collected during a payment card transaction (e.g., a behavioral biometric sample).

In some embodiments, transaction venue may be any venue in which a consumer such as suspect consumer 622 interacts with transaction device 624 during a payment card transaction. In some embodiments, transaction venue 620 is a traditional brick-and-mortar storefront or other physical venue of merchant 628. In other embodiments, transaction venue 620 may be a merchant's online presence or other virtual venue such as, for example, the merchant's web site or other Internet-based sales venue. In still other embodiments, transaction venue 620 may be an interface or application through merchant's 628 mobile computing app, or a kiosk-type venue, or an automated teller machine (ATM), or a toll booth.

Further, in some embodiments, transaction device 624 may be any type of device with which a consumer such as suspect consumer 622 interacts during a payment card transaction, and in which behavioral biometric sample data may be captured. In some embodiments, transaction device 624 is a point-of-sale device such as a traditional card swipe, keypad device, or touch screen device. In other embodiments, transaction device 624 is a personal computing device such as a desktop computer, a laptop computer, a tablet computing device, or other handheld or wearable computing device. In still other embodiments, transaction device 624 may be a keypad, a touchscreen, or other button-driven device associated with, for example, an ATM or a kiosk venue.

In the example embodiment, behavioral profiles 616 include behavioral biometric data and/or features associated with sample actions or behaviors of cardholder 612 (i.e., reference biometric data). In the example embodiment, behavioral biometric data includes one or more behavioral biometric samples collected from an individual such as cardholder 612 or consumer 622. As used herein, the term “behavioral biometric sample” is used generally to refer to behavioral data, values, features, or aspects of a person's conduct collected during an event and, more specifically, during a real or simulated payment card transaction event. For example, some behavioral biometric samples may include keystroke dynamics, values or features associated with an individual's operation of a keyboard or key pad.

Behavioral biometrics may be grouped into the type of behavior being captured and analyzed (sometimes referred to herein as a “behavior type”). In some embodiments, behavioral profile 616 includes behavioral biometric samples of keystroke dynamics. Keystroke dynamics may include, for example and without limitation, the total elapsed time taken for suspect consumer 622 to enter a personal identification number (PIN) code into, e.g., a point-of-sale device during a payment card transaction, or the time spacing between keystrokes on a keyboard or a tablet input device during, e.g., entering data into a data field during an online transaction, or the speed of using an interface, or the time taken moving from page to page of an online web site, or reading instructions, or performing a required task. Keystroke dynamics may be collected from, for example, a point-of-sale device, or a desktop or laptop computer keyboard, or a mobile computing device's physical or virtual keyboard, or from any of the devices associated with various venues 620 as described above.

In still other embodiments, behavioral profile 616 includes behavioral biometric samples of mouse-related behaviors (“mouse dynamics”). During online transactions, users of desktop or laptop computers may interact with the computer with a mouse or similar input device, such as a touch-screen interface. Mouse dynamics data may be captured and analyzed as a part of authenticating, for example, an online suspect consumer. Mouse dynamics may include, for example, the timing of a double-click rate of a mouse button, or the timing of a click and release of a mouse button, or focus-related data for where and when a user moves the mouse pointer to particular positions on a display device during the payment card transaction, or idle placement of the mouse on the screen, or scrolling using the keyboard or a mouse wheel or onscreen arrows.

In some embodiments, behavioral profile 616 includes data associated with a two-step verification process. In some known two-step verification processes, a payment card transaction initiated using a first device is also verified through a second device prior to completion. For example, in one known process, a suspect consumer initiates a payment card transaction at a point-of-sale device or at a merchant's online web site (e.g., the first device). During the authentication process, a text message or an email that includes a verification code is transmitted to the cardholder's mobile phone or email account. If the suspect consumer is actually the cardholder, then the cardholder will access the verification code through their second device and provide the code to complete the transaction. In the example embodiment, behavioral profile 616 may include timing data associated with how long it takes cardholder 612 to enter the code from, for example, the time of the transmittal to the secondary device. Behavioral profile 616 may also include which secondary device or other avenue of reception (e.g., email) is used, or the key stroke dynamics associated with entering the “random” verification code sent to the cardholder.

In other embodiments, behavioral profile 616 includes cognition-related behavioral data, or data that evinces an underlying state of mind or other behavioral characteristic that may distinguish some individuals from others. For example, some people may ritualistically tip a certain percentage of their total bill, or round up to the nearest dollar, or to otherwise make a round number, or always tip exactly 15%, or may always include the tip in the original transaction, or add the tip in after the original transaction. As such, aspects of these behavioral tendencies may be captured and used for authenticating the suspect consumer.

In still other embodiments, behavioral profile 616 includes signature-related behavioral data (“signature dynamics”). Signature-related behavioral data samples may include, for example, a static image of a completed signature. Signature-related behavioral data samples may also include timing data associated with the creation and capture of an electronic signature through, for example, a signature capture device. Some users may have distinctive timing characteristics while writing their signature that may not be apparent or determinable from just an examination of the completed image. For example, some users my dot their “I's” or cross their “T's” at differing times during the writing of the signature, or they may take a relatively-longer or shorter time to write their signature. For another example, writing pressure on the screen may be captured, or a number of attempts at the signature, or the number of times the writing implement is removed and placed back onto the writing surface while making the signature. As such, these particular aspects of dynamically generating an electronic signature may be captured and used for authenticating the suspect consumer.

Moreover, in some embodiments, profile 616 may also include behavioral biometric data and/or behavioral data associated with online transactions. Such data may include, for example, a total timing to conduct an entire transaction, a timing to conduct one or more operations of a transaction, behavioral data indicating how the cardholder traverses or otherwise interacts with the merchant's online site, and tendencies associated with payment type (e.g., which card or payment type is normally used, or which card or other data from a digital wallet is normally used).

In some embodiments, the reference biometric data may include one or more reference samples collected from cardholder 612 during, for example, a configuration session conducted by issuer 614 with cardholder 612 during a registration process. In other embodiments, this reference biometric data may include one or more reference samples collected from cardholder 612 during one or more payment card transactions (e.g., historical samples from past transactions). Further, in some embodiments, the reference biometric data may include a single reference sample, or may include a plurality of reference samples, or may include an aggregate reference sample in which a plurality of reference samples are combined or aggregated into an “average” sample, or a sample plus a measure of a standard deviation from that average sample. In other embodiments, an initial behavioral profile for cardholder 612 is defined from factors other than reference samples. For example, cardholder 612 may start out with a basic behavioral biometric profile determined based on age, gender, or other demographic information. This basic profile may then be modified or replaced as reference samples are collected during payment card transactions.

Further, in some embodiments, each profile 616 is associated with a venue type. Venue types are identifiers used by authentication system 650 to distinguish between different sets of biometric sample types. Because some behavioral biometrics may be particular to certain transaction devices or transaction venues, authentication system 650 may implement a venue type identifier for various types of venues, and behavioral data may be submitted with that venue type, or the venue type may be determined by authentication system 650 based on the type of behavioral biometric data received.

In other embodiments, profile 616 may also include additional behavioral data not associated strictly with biometrics. For example, profile 616 may also include purchase tendency data such as what types of goods and services cardholder 612 traditionally purchases, from where cardholder 612 normally purchases goods and services, and how cardholder 612 uses their payment card (e.g., number of items normally purchased, tendency toward number of uses within a single large store, or quantity of goods/services normally purchased).

During operation, authentication system 650, in the example embodiment, receives at least behavioral data 626 and payment card data associated with the payment card transaction. Further, authentication system receives one or more behavioral profiles 616 associated with approved cardholder 612 (i.e., the cardholder associated with the payment card being presented in the transaction). In some embodiments, behavioral data 626 indicates a venue type, and authentication system 650 uses the venue type to identify an appropriate behavioral profile 616 for use. Further, in some embodiments, authentication system 650 provides a primary account number (PAN) associated with the transaction to issuer 614, and issuer 614 thereby provides cardholder's 612 behavioral profile data 616.

Authentication system 650 then authenticates the transaction by comparing behavioral data 626 of suspect consumer 622 with behavioral profile 616 of approved cardholder 612 and generating an authentication value from the comparison. In some embodiments, authentication system 650 provides a discrete determination of authentication (e.g., where the authentication value represents either failure or success), and the transaction is either denied as unauthenticated or approved and allowed to proceed successfully authenticated. In other embodiments, authentication system 650 provides an authentication score (value) that may be used by an interchange network or other related party as a factor on whether or not to authenticate or authorize the transaction. In some embodiments, authentication system 650 considers other authentication factors 652 such as those traditionally analyzed during authentication. As such, the behavioral biometric authentication may be leveraged by authentication system 650 as one factor of overall authentication of the transaction. Further, the composure or factors used to generate the authentication score may depend on availability of behavioral data 626 within the particular transaction. For example, not all signature pads may have force applied to create the signature. As such, the presence or absence of the ability to collect aspects of behavioral biometrics may change the composure of the authentication score.

In some embodiments, authentication system 650 may compare profile 616 with behavioral data 626 using statistical analysis methods. In one embodiment, one or more threshold values are pre-defined and indicates a number of standard deviations that is acceptable for authentication. In another embodiment, the one or more threshold values are variable, and are computed based on one or more influencing factors. For example, profile 616 and/or behavioral data 626 may be altered based on the time of day (e.g., cardholder 612 may be faster in typing their PIN in the morning than at night), or the type of merchant (e.g., merchant 628 may have a tendency to delay the process longer than other merchants), or the type of device (e.g., transaction device 624 may be slower or faster than other devices).

Further, in some embodiments, the behavioral biometric scoring may be a partial factor used in conjunction with other screening and/or fraud methodologies. The behavioral biometric scoring may be used as an additional metric in giving greater detail as to the authenticity of a transaction.

In the example embodiments described herein, some transactions may be card-present transactions in which the suspect consumer presents a physical payment card for use in the transaction. Other transactions may be card-not-present transactions in which the suspect consumer presents a payment card for use without presenting the physical payment card itself, such as, for example, entering a primary account number (PAN) of the payment card through an online payment processing site of a merchant. As used herein, the term “presenting a payment card for use” is used broadly to cover any of these methods.

It should be understood that the above description of the various types of data associated with behavioral profiles also applies to the types of behavioral biometric sample data that may be collected. In other words, and for example, when the profile is discussed as including keystroke dynamics data, it is also implied that behavioral biometric sample data may also include keystroke dynamics data.

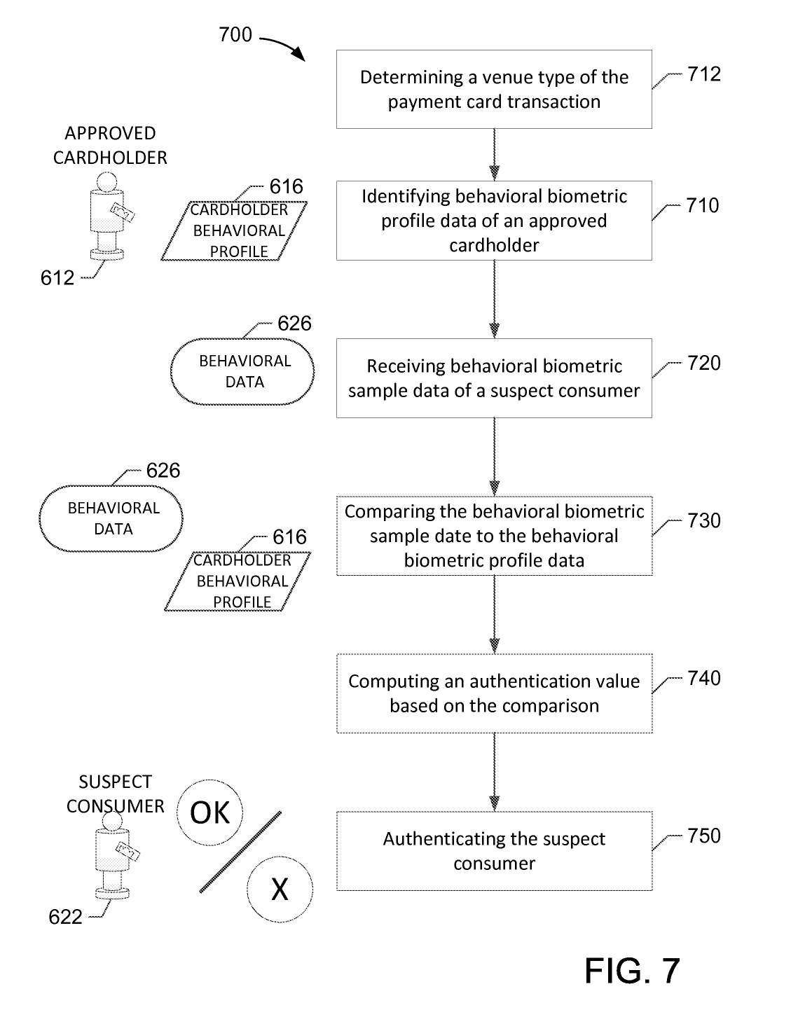

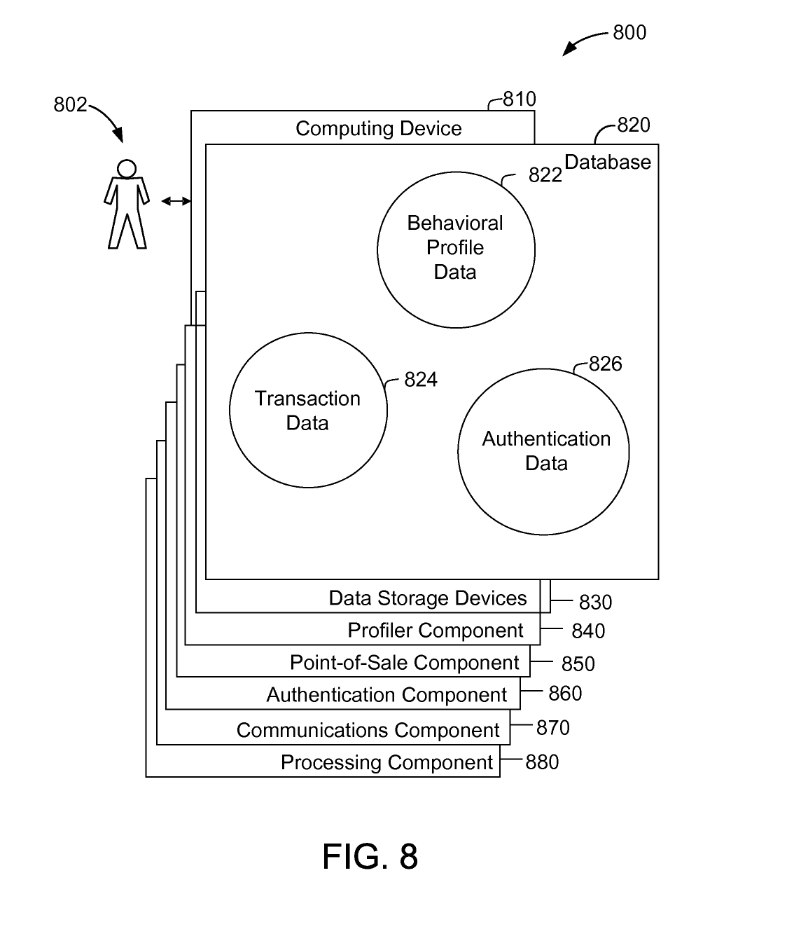

FIG. 7 is an example method 700 for authenticating suspect consumers during payment card transactions in a payment card transaction environment 600 such as shown in FIG. 6. In the example embodiment, method 700 is performed by one or more computing systems such as server 112 (shown in FIG. 2), authentication system 122 (shown in FIG. 3), or by computing device 810 (shown in FIG. 8). In the example embodiment, method 700 includes identifying 710 behavioral biometric profile data of an approved cardholder that is approved to use a payment card issued by an issuer. In some embodiments, identifying behavioral biometric profile data further includes identifying behavioral biometric profile data collected from one or more historical payment card transactions. In other embodiments, identifying behavioral biometric profile data further includes identifying behavioral biometric profile data sampled from the approved cardholder during a registration process. In still other embodiments, method 700 includes determining 712 a venue type associated with the payment card transaction, and identifying 710 behavioral biometric profile data further includes identifying behavioral biometric profile data matching the venue type.

In the example embodiment, method 700 also includes receiving 720 behavioral biometric sample data of a suspect consumer collected during a payment card transaction in which the suspect consumer presents the payment card for use. In some embodiments, receiving 720 behavioral biometric sample data further includes receiving behavioral biometric sample data at a point-of-sale device within a merchant's business premise, wherein the behavioral biometric sample data includes one or more of keystroke dynamics and signature dynamics. In other embodiments, receiving 720 behavioral biometric sample data further includes receiving behavioral biometric sample data from a computing device remote from a merchant's business premise, wherein the behavioral biometric sample data includes one or more of keystroke dynamics and mouse dynamics. In still other embodiments, receiving 720 behavioral biometric sample data further includes receiving behavioral biometric sample data including cognition-related behavioral data. In further embodiments, receiving 720 behavioral biometric sample data further include receiving behavioral biometric sample data including timing data associated with behaviors performed by the suspect consumer during the payment card transaction.

Method 700, in the example embodiment, also includes comparing 730 the behavioral biometric sample data of the suspect consumer to the behavioral biometric profile data of the approved cardholder and computing 740 an authentication value based at least in part on the comparing. Method 700 also includes authenticating the suspect consumer as the approved cardholder based at least in part on the authentication value.

FIG. 8 shows an example configuration 800 of a database 820 within a computing device 810, along with other related computing components, that may be used to authenticate a suspect consumer in a payment card transaction environment such as transaction environment 600 (shown in FIG. 6). In some embodiments, computing device 810 is similar to server system 112 (shown in FIG. 2), authentication system 122 (shown in FIG. 3), and/or server system 301 (shown in FIG. 5). Database 820 is coupled to several separate components within computing device 810, which perform specific tasks.

In the example embodiment, database 820 includes behavioral profile data 822, transaction data 824, and authentication data 826. In some embodiments, database 820 is similar to database 120 (shown in FIG. 2). Behavioral profile data 822 includes information associated with behavioral biometric data and samples collected or created from approved cardholders (e.g., behavioral profiles 616 associated with cardholders 612 shown in FIG. 6). Transaction data 824 includes information associated with payment card transactions, including behavioral data collected from a suspect consumer (e.g., behavioral data 626 collected in a transaction venue 620 from suspect consumer 622 shown in FIG. 6). Authentication data 826 includes data associated with authentication of suspect consumers during payment card transactions, including information associated with comparing behavioral samples of suspect consumers with behavioral profiles of approved cardholders.

Computing device 810 includes the database 820, as well as data storage devices 830. Computing device 810 also includes a profiler component 840 for capturing and/or creating behavioral profiles 616. Computing device 810 also includes a point-of-sale component 850 such as transaction device 624 (shown in FIG. 6) for capturing samples of suspect consumers during payment card transactions. Computing device 810 also includes an authentication component 860 for comparing behavioral profile data 822 to suspect consumer samples from transaction data 824. A communications component 870 is also included for communicating with other servers or entities during authentication of suspect consumers. A processing component 880 assists with execution of computer-executable instructions associated with the system.

As will be appreciated based on the foregoing specification, the above-described embodiments of the disclosure may be implemented using computer programming or engineering techniques including computer software, firmware, hardware or any combination or subset thereof, wherein the technical effect is a flexible system for communicating liability acceptance for payment card transactions. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-based method for consumer authentication of payment card transactions using behavioral biometrics, the method using a computer device including a processor and a memory, said method comprising:
identifying behavioral biometric profile data of an approved cardholder that is approved to use a payment card issued by an issuer;
receiving behavioral biometric sample data of a suspect consumer collected during a payment card transaction in which the suspect consumer presents the payment card for use;
comparing the behavioral biometric sample data of the suspect consumer to the behavioral biometric profile data of the approved cardholder;
computing an authentication value based at least in part on the comparing; and
authenticating the suspect consumer as the approved cardholder based at least in part on the authentication value.

2. The method of claim 1, wherein receiving behavioral biometric sample data further includes receiving behavioral biometric sample data at a point-of-sale device within a merchant's business premise, wherein the behavioral biometric sample data includes one or more of keystroke dynamics and signature dynamics.

3. The method of claim 1, wherein receiving behavioral biometric sample data further includes receiving behavioral biometric sample data from a computing device remote from a merchant's business premise, wherein the behavioral biometric sample data includes one or more of keystroke dynamics and mouse dynamics.

4. The method of claim 1, wherein receiving behavioral biometric sample data further includes receiving behavioral biometric sample data including cognition-related behavioral data.

5. The method of claim 1, wherein receiving behavioral biometric sample data further include receiving behavioral biometric sample data including timing data associated with behaviors performed by the suspect consumer during the payment card transaction.

6. The method of claim 1 further comprising determining a venue type associated with the payment card transaction, wherein identifying behavioral biometric profile data further includes identifying behavioral biometric profile data matching the venue type.

7. The method of claim 1, wherein identifying behavioral biometric profile data further includes identifying behavioral biometric profile data collected from one or more historical payment card transactions.

8. The method of claim 1, wherein identifying behavioral biometric profile data further includes identifying behavioral biometric profile data sampled from the approved cardholder during a registration process.

9. A computing device for consumer authentication of payment card transactions using behavioral biometrics, said computing device comprising a processor communicatively coupled to a memory, said computing device programmed to:
identify behavioral biometric profile data of an approved cardholder that is approved to use a payment card issued by an issuer;
receive behavioral biometric sample data of a suspect consumer collected during a payment card transaction in which the suspect consumer presents the payment card for use;
compare the behavioral biometric sample data of the suspect consumer to the behavioral biometric profile data of the approved cardholder;
compute an authentication value based at least in part on the comparing; and
authenticate the suspect consumer as the approved cardholder based at least in part on the authentication value.

10. The computing device of claim 9, wherein receiving behavioral biometric sample data further includes receiving behavioral biometric sample data at a point-of-sale device within a merchant's business premise, wherein the behavioral biometric sample data includes one or more of keystroke dynamics and signature dynamics.

11. The computing device of claim 9, wherein receiving behavioral biometric sample data further includes receiving behavioral biometric sample data from a computing device remote from a merchant's business premise, wherein the behavioral biometric sample data includes one or more of keystroke dynamics and mouse dynamics.

12. The computing device of claim 9, wherein receiving behavioral biometric sample data further includes receiving behavioral biometric sample data including cognition-related behavioral data.

13. The computing device of claim 9, wherein receiving behavioral biometric sample data further include receiving behavioral biometric sample data including timing data associated with behaviors performed by the suspect consumer during the payment card transaction.

14. The computing device of claim 9, wherein said computing device is further programmed to determine a venue type associated with the payment card transaction, wherein identifying behavioral biometric profile data further includes identifying behavioral biometric profile data matching the venue type.

15. The computing device of claim 9, wherein identifying behavioral biometric profile data further includes receiving behavioral biometric profile data collected from one or more historical payment card transactions.

16. The computing device of claim 9, wherein identifying behavioral biometric profile data further includes receiving behavioral biometric profile data sampled from the approved cardholder during a registration process.

17. At least one non-transitory computer-readable storage media having computer-executable instructions embodied thereon, wherein when executed by at least one processor, the computer-executable instructions cause the processor to:
identify behavioral biometric profile data of an approved cardholder that is approved to use a payment card issued by an issuer;
receive behavioral biometric sample data of a suspect consumer collected during a payment card transaction in which the suspect consumer presents the payment card for use;
compare the behavioral biometric sample data of the suspect consumer to the behavioral biometric profile data of the approved cardholder;
compute an authentication value based at least in part on the comparing; and
authenticate the suspect consumer as the approved cardholder based at least in part on the authentication value.

18. The computer-readable storage media of claim 17, wherein receiving behavioral biometric sample data further includes receiving behavioral biometric sample data at a point-of-sale device within a merchant's business premise, wherein the behavioral biometric sample data includes one or more of keystroke dynamics and signature dynamics.

19. The computer-readable storage media of claim 17, wherein receiving behavioral biometric sample data further includes receiving behavioral biometric sample data from a computing device remote from a merchant's business premise, wherein the behavioral biometric sample data includes one or more of keystroke dynamics and mouse dynamics.

20. The computer-readable storage media of claim 17, wherein receiving behavioral biometric sample data further includes receiving behavioral biometric sample data including cognition-related behavioral data.

21. The computer-readable storage media of claim 17, wherein receiving behavioral biometric sample data further include receiving behavioral biometric sample data including timing data associated with behaviors performed by the suspect consumer during the payment card transaction.

22. The computer-readable storage media of claim 17, wherein the computer-executable instructions further cause the processor to determine a venue type associated with the payment card transaction, wherein identifying behavioral biometric profile data further includes identifying behavioral biometric profile data matching the venue type.

23. The computer-readable storage media of claim 17, wherein identifying behavioral biometric profile data further includes receiving behavioral biometric profile data collected from one or more historical payment card transactions.

24. The computer-readable storage media of claim 17, wherein identifying behavioral biometric profile data further includes receiving behavioral biometric profile data sampled from the approved cardholder during a registration process.
